(19) United States
(12) Patent Application Publication
(10) Pub. No.: US 2012/0048019 A1
(43) Pub. Date: Mar. 1, 2012

(54) HIGHLY SENSITIVE CAPACITIVE SENSOR AND METHODS OF MANUFACTURING THE SAME

(76) Inventors: Hanqin Zhou, Wuxi (CN); Leyue Jiang, Wuxi (CN); Mathew Varghese, Arlington, MA (US); Haidong Liu, Wuxi (CN)

(21) Appl. No.: 12/869,222

(22) Filed: Aug. 26, 2010

(51) Int. Cl. G01P 15/125; C23F 1/00

(52) U.S. Cl. 73/514.32; 216/13

(57) ABSTRACT

Micro-machined capacitive sensors implemented in micro-electro-mechanical system (MEMS) processes that have higher sensitivity, while providing an increased linear capacitive sensing range. Capacitive sensing is achieved via variable-area sensing, which employs a transduction mechanism in which the relationship between changes in the capacitance of variable, parallel-plate capacitors and displacements of a proof mass is generally linear. Each respective variable, parallel-plate capacitor is formed by a finger/electrode pair, in which both the finger and the electrode have rectangular tooth profiles that include a plurality of rectangular teeth. Because changes in the overlapping area of the finger and the electrode are multiplied by the number of rectangular teeth, while the standing capacity of the micro-machined capacitive sensor remains relatively high, the sensitivity of the micro-machined capacitive sensor employing variable-area sensing is significantly increased per unit area of the finger and the electrode.

### STATEMENT REGARDING FEDERALLY SPONSORED RESEARCH OR DEVELOPMENT

Not applicable

### FIELD OF THE INVENTION

The present application relates generally to micro-electro-mechanical systems (MEMS) and devices, and more specifically to micro-machined capacitive sensors and their implementations in MEMS processes.

### BACKGROUND OF THE INVENTION

In recent years, micro-machined capacitive sensors have been increasingly employed for providing inertial sensing in an array of automotive and consumer electronics applications. A typical micro-machined capacitive sensor implemented in a micro-electro-mechanical system (MEMS) process (referred to herein as the “typical MEMS capacitive sensor”) includes a substrate, a proof mass, a plurality of spring beams tethering the proof mass to the substrate, a plurality of fingers extending from the proof mass, and a plurality of electrodes attached to the substrate having readout elements extending therefrom. In the typical MEMS capacitive sensor, the plurality of fingers extending from the proof mass are disposed adjacent to the respective electrodes attached to the substrate, thereby forming variable gaps between pairs of the adjacent fingers and electrodes. Further, a dielectric material (e.g., the air) is disposed in the gap space between each the finger/electrode pair. Each respective finger/electrode pair with the dielectric material disposed in the gap space therebetween forms a variable, parallel-plate capacitor.

In the typical MEMS capacitive sensor described above, capacitive sensing is based on the relationship between changes in the capacitance of the variable, parallel-plate capacitors and displacements of the proof mass. For example, the capacitance of each of the variable, parallel-plate capacitors can be calculated using the expression,

$$C = \frac{ɛ \cdot A}{z} , \qquad ( 1 )$$

in which “∈” represents the permittivity of the dielectric material (e.g., the air) disposed in the gap space between the parallel plates, “A” represents the overlapping area of the parallel plates, and “z” represents the variable gap distance between the parallel plates.

Accordingly, in the typical MEMS capacitive sensor, capacitive sensing is achieved via what is referred to herein as “variable-gap sensing”, which employs a transduction mechanism that can be express as follows,

$$\vert \frac{d C}{d z} \vert = \frac{ɛ \cdot x \cdot y}{{z}^{2}} -> Δ {C}_{z} = \frac{ɛ \cdot x \cdot y}{{z}^{2}} \cdot Δ z , \qquad ( 2 )$$

in which “x·y” is equal to A, i.e., the overlapping area of the parallel plates, “Δz” represents a change in the gap distance, z, and “ΔC_{z}” represents a change in the capacitance of the variable, parallel-plate capacitors due to relative movement of the parallel plates, causing the corresponding change, Δz, in the gap distance, z, between the parallel plates. It is noted that the change, Δz, in the gap distance, z, between the parallel plates is responsive to the displacement of the proof mass. Because the gap distance, z, can be made small while the standing capacity of the MEMS capacitive sensor remains relatively high, the sensitivity of the MEMS capacitive sensor employing variable-gap sensing is generally considered to be high.

One drawback of the typical MEMS capacitive sensor employing variable-gap sensing is that the relationship between the change in the capacitance, ΔC_{z}, of the variable, parallel-plate capacitors and the displacement of the proof mass is non-linear, as demonstrated by the term “z²” in the denominator of equation (2) above. The capacitive sensing range of the typical MEMS capacitive sensor employing variable-gap sensing is therefore generally non-linear. Moreover, the relative movement of the parallel plates of the respective parallel-plate capacitors can cause the dielectric material (e.g., the air) to rush into and/or out of the gap space between the parallel plates, resulting in a significant damping effect referred to herein as “squeeze-film damping”. Because the effective damping coefficient associated with squeeze-film damping can change depending on how close the parallel plates are to one another, squeeze-film damping is generally considered to be highly non-linear. Accordingly, such squeeze-film damping can exacerbate the inherent non-linearity of the capacitive sensing range of the typical MEMS capacitive sensor employing variable-gap sensing.

It would therefore be desirable to have micro-machined capacitive sensors implemented in micro-electro-mechanical system (MEMS) processes that avoid at least some of the drawbacks of the typical MEMS capacitive sensor described above.

### BRIEF SUMMARY OF THE INVENTION

In accordance with the present application, micro-machined capacitive sensors implemented in micro-electro-mechanical system (MEMS) processes are disclosed that have high sensitivity, while providing an increased linear capacitive sensing range.

In accordance with one aspect, a micro-machined capacitive sensor implemented in a MEMS process includes a substrate, a proof mass, a plurality of spring beams tethering or otherwise coupling the proof mass to the substrate, at least one finger extending from the proof mass, and at least one electrode attached to the substrate having a respective readout element extending therefrom. The finger extending from the proof mass is disposed adjacent to the electrode attached to the substrate, thereby forming a substantially invariable gap between the finger and the electrode. The micro-machined capacitive sensor further includes a dielectric material (e.g., the air) disposed in the gap space between the finger and the electrode. The finger/electrode pair with the dielectric material disposed in the gap space therebetween forms a variable, parallel-plate capacitor.

In accordance with the disclosed micro-machined capacitive sensor, capacitive sensing is based on the relationship between changes in the capacitance of the variable, parallel-plate capacitor and displacements of the proof mass. In accordance with one exemplary aspect, capacitive sensing is achieved via what is referred to herein as “variable-area sensing”, which employs a transduction mechanism in which the relationship between the changes in the capacitance of the variable, parallel-plate capacitor and the displacements of the proof mass is generally linear. The capacitive sensing range of the micro-machined capacitive sensor employing variable-area sensing is therefore generally linear. Each change in the capacitance of the variable, parallel-plate capacitor is due to relative movement of the finger and the electrode, causing a corresponding change in an overlapping area of the finger and the electrode. Such changes in the overlapping area of the finger and the electrode are responsive to the displacements of the proof mass. Further, the relative movement of the finger and the electrode across the dielectric material disposed in the gap space between the finger and the electrode results in a damping effect referred to herein as “slide-film damping”, which generally has negligible effect on the linearity of the micro-machined capacitive sensor.

In accordance with a further exemplary aspect, both the finger and the electrode in the finger/electrode pair have rectangular tooth profiles that include at least two substantially rectangular teeth. Because changes in the overlapping area of the finger and the electrode are multiplied by the number of rectangular teeth, while the standing capacity of the micro-machined capacitive sensor remains relatively high, the sensitivity of the disclosed micro-machined capacitive sensor employing variable-area sensing is significantly increased per unit area of the finger and the electrode.

Other features, functions, and aspects of the invention will be evident from the Drawings and/or the Detailed Description of the Invention that follow.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a simplified, perspective view of an exemplary parallel-plate capacitor for use in describing variable-area sensing;

FIG. 2 is a plan view of an exemplary micro-machined capacitive sensor employing variable-area sensing, according to the present application;

FIG. 3a is a perspective view of an exemplary finger/electrode pair included in the micro-machined capacitive sensor of FIG. 2;

FIG. 3b is a plan view of the finger/electrode pair of FIG. 3a;

FIG. 4a is a perspective view of an alternative embodiment of the exemplary finger/electrode pair of FIG. 3a, in which both of the finger and the electrode have rectangular tooth profiles;

FIG. 4b is a plan view of the finger/electrode pair having rectangular tooth profiles of FIG. 4a; and

FIGS. 5a-5e illustrate an exemplary fabrication process flow for producing the micro-machined capacitive sensor of FIG. 2, including finger/electrode pairs having rectangular tooth profiles, according to the present application.

### DETAILED DESCRIPTION OF THE INVENTION

Micro-machined capacitive sensors implemented in micro-electro-mechanical system (MEMS) processes are disclosed that have high sensitivity, while providing a relatively large linear capacitive sensing range. In accordance with the disclosed micro-machined capacitive sensors, capacitive sensing is achieved via what is referred to herein as “variable-area sensing”, which employs a transduction mechanism in which the relationship between changes in the capacitance of variable, parallel-plate capacitors and displacements of a proof mass is generally linear. Each respective parallel-plate capacitor is formed by a finger/electrode pair, in which both the finger and the electrode have rectangular tooth profiles that include a number of substantially rectangular teeth. Because changes in an overlapping area of the parallel plates are multiplied by the number of rectangular teeth, while the standing capacity of the micro-machined capacitive sensor remains relatively high, the sensitivity of the micro-machined capacitive sensor employing variable-area sensing is significantly increased per unit area of the finger and the electrode.

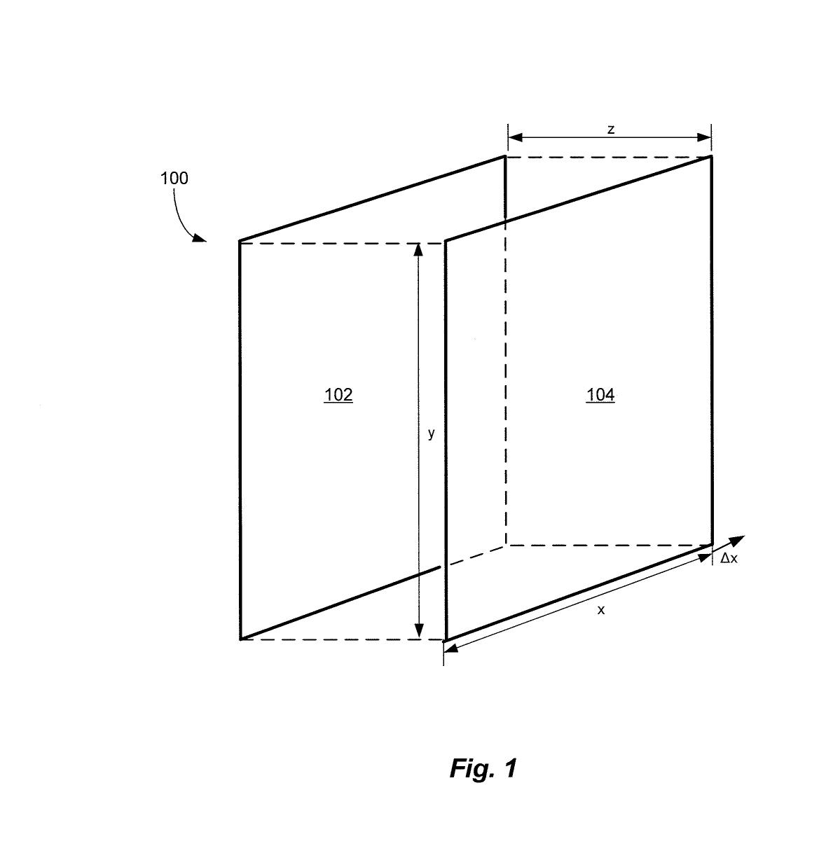

FIG. 1 depicts a simplified, perspective view of an exemplary parallel-plate capacitor 100 for use in describing variable-area sensing. As shown in FIG. 1, the capacitor 100 includes two electrode plates 102, 104 that are substantially parallel to one another. The electrodes plates 102, 104 are separated from one another by a substantially invariable gap distance, z. The gap space formed by the invariable gap distance, z, between the electrode plates 102, 104 is filled with a dielectric material, such as the air or any other suitable dielectric material.

For example, the capacitance of the exemplary parallel-plate capacitor 100 of FIG. 1 can be calculated using the expression,

$$C = \frac{ɛ \cdot A}{z} , \qquad ( 3 )$$

in which “∈” represents the permittivity of the dielectric material (e.g., the air) disposed in the gap space between the electrode plates 102, 104, “A” represents an overlapping area of the electrode plates 102, 104, and “z” represents the invariable gap distance between the electrode plates 102, 104. As shown in FIG. 1, the overlapping area, A, of the electrode plates 102, 104 is equal to “x·y”, in which “x” and “y” represent the width and the height, respectively, of the overlapping area, A. The overlapping area, A, of the electrode plates 102, 104, can be made to vary by relative movement of the electrode plates 102, 104, thereby varying the dimension, x, of the overlapping area, A, by an amount, Δx, while the dimension, y, of the overlapping area, A, remains substantially unchanged. During such relative movement of the electrode plates 102, 104, the electrode plates 102, 104 remain substantially parallel to one another and separated by the invariable gap distance, z.

It is noted that parallel-plate capacitors like the exemplary parallel-plate capacitor 100 of FIG. 1 may be employed in a micro-machined capacitive sensor implemented in a micro-electro-mechanical system (MEMS) process (referred to herein as the “MEMS capacitive sensor”). In the MEMS capacitive sensor, capacitive sensing is achieved via variable-area sensing, which employs a transduction mechanism that can be expressed as follows,

$$\vert \frac{d C}{d x} \vert = \frac{ɛ \cdot y}{z} -> Δ {C}_{x} = \frac{ɛ \cdot y}{z} \cdot Δ x , \qquad ( 4 )$$

in which “Δx” represents a change in the width, x, of the overlapping area, A, of the electrode plates 102, 104, and “ΔCₓ” represents a change in the capacitance of the capacitor 100 due to the relative movement of the electrode plates 102, 104. In the MEMS capacitive sensor, the change, Δx, in the width, x, of the overlapping area, A, is responsive to the displacement of a proof mass. It is noted that the relationship between the change in the capacitance, ΔCₓ, of the capacitor 100 and the displacement of the proof mass is generally linear, as demonstrated by the constant multiplier,

$$`` \frac{ɛ \cdot y}{z} ″ ,$$

in equation (4) above. The capacitive sensing range of the MEMS capacitive sensor employing variable-area sensing is therefore generally linear. It is further noted that the relative movement of the electrode plates 102, 104 across the dielectric material disposed in the gap space between the electrode plates 102, 104 results in a damping effect referred to herein as “slide-film damping”, which generally has negligible effect on the linearity of the MEMS capacitive sensor.

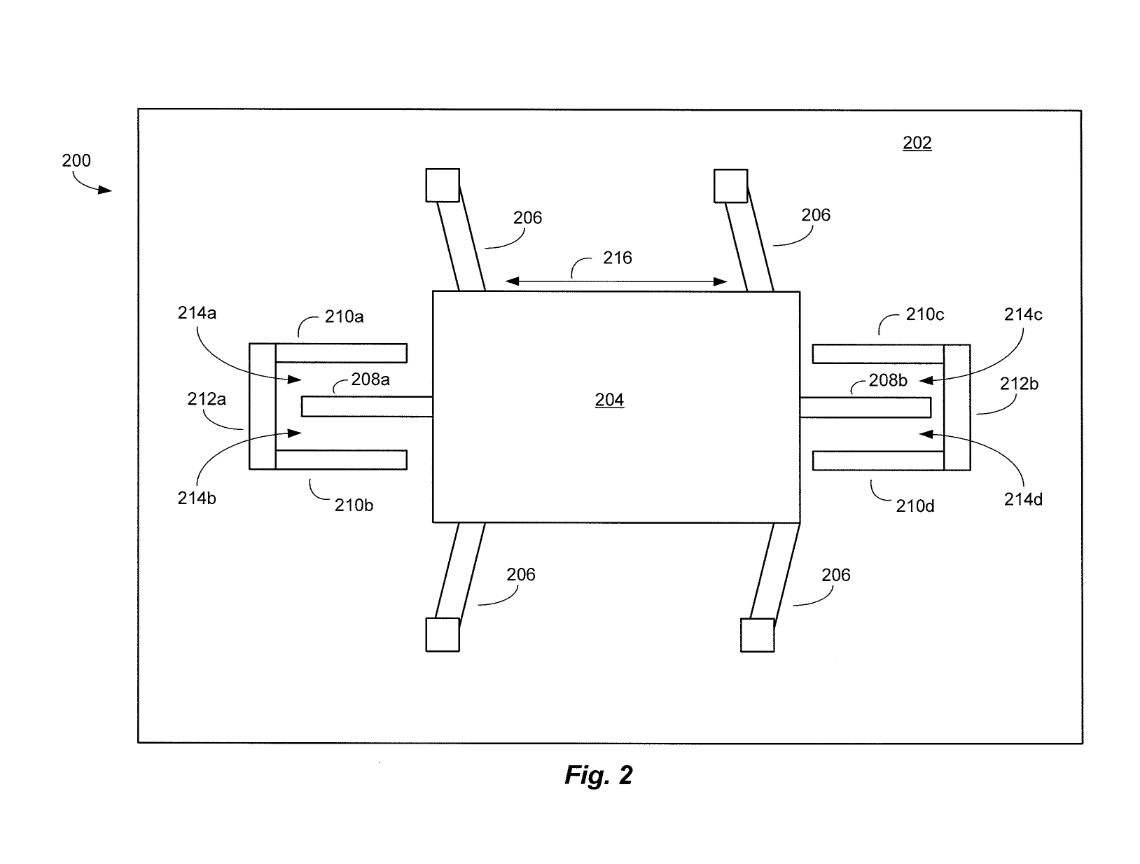

FIG. 2 depicts an illustrative embodiment of an exemplary MEMS capacitive sensor 200 in which capacitors like the exemplary parallel-plate capacitor 100 of FIG. 1 may be employed. In the illustrated embodiment, the MEMS capacitive sensor 200 includes a substrate 202, a proof mass 204, a plurality of spring beams 206 tethering or otherwise coupling the proof mass 204 to the substrate 202, a plurality of electrode plates 208a, 208b (also referred to herein as the “fingers 208a, 208b”) extending from the proof mass 204, and a plurality of electrode plates 210a, 210b, 210c, 210d (also referred to herein as the “electrodes 210a, 210b, 210c, 210d”) attached to the substrate 202 having readout elements 212a, 212b extending therefrom. The finger 208a extending from the proof mass 204 is disposed adjacent to the respective electrodes 210a, 210b attached to the substrate 202, thereby forming a substantially invariable gap 214a between the finger 208a and the electrode 210a, and a substantially invariable gap 214b between the finger 208a and the electrode 210b. Similarly, the finger 208b extending from the proof mass 204 is disposed adjacent to the respective electrodes 210c, 210d attached to the substrate 202, thereby forming a substantially invariable gap 214c between the finger 208b and the electrode 210c, and a substantially invariable gap 214d between the finger 208b and the electrode 210d. Each of the gap spaces formed by the invariable gaps 214a, 214b, 214c, 214d is filled with a dielectric material, such as the air or any other suitable dielectric material. Accordingly, each respective finger/electrode pair 208a/210a, 208a/210b, 208b/210c, 208b/210d with the dielectric material disposed in the gap space therebetween forms a variable, parallel-plate capacitor that functions like the capacitor 100 of FIG. 1.

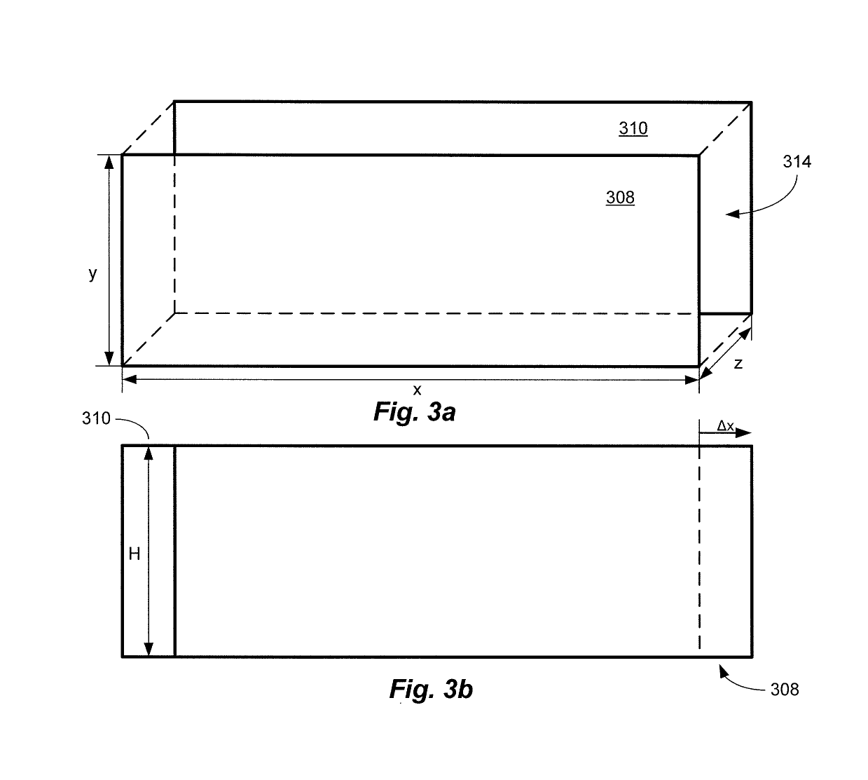

FIG. 3a depicts an exemplary embodiment 308 (also referred to herein as the “finger 308”) of the finger 208a of FIG. 2, and an exemplary embodiment 310 (also referred to herein as the “electrode 310”) of the electrode 210a of FIG. 2. It is noted that the finger 208b of FIG. 2 can be configured like the finger 308, and that each of the electrodes 210b, 210c, 210d of FIG. 2 can be configured like the electrode 310. Like the finger 208a, the finger 308 is configured to extend from the proof mass 204, and, like the electrode 210a, the electrode 310 is configured to be attached to the substrate 202. The finger 308 extending from the proof mass 204 is disposed adjacent to the electrode 310 attached to the substrate 202, thereby forming a substantially invariable gap 314 between the finger 308 and the electrode 310. The gap space formed by the invariable gap 314 is filled with a dielectric material, such as the air or any other suitable dielectric material. As shown in FIG. 3a, “x” and “y” represent the width and the height, respectively, of an overlapping area, “A₁”, of the finger 308 and the electrode 310.

FIG. 3b depicts a plan view of the finger 308 and the electrode 310. The finger 308 and the electrode 310 with the dielectric material disposed in the gap space therebetween forms a variable, parallel-plate capacitor. For example, if the height, y, of the overlapping area, A₁, were set equal to a constant value “H”, then a change, ΔA₁, in the overlapping area, A₁, may be expressed as follows,

ΔA₁=H·Δx. (5)

in which “Δx” represents a change in the width, x, of the overlapping area, A₁, caused by relative movement of the finger 308 and the electrode 310 in response to a displacement of the proof mass 204 (as indicated by an arrow 216; see FIG. 2). Moreover, for the finger/electrode pair 308/310, capacitive sensing is achieved via variable-area sensing, for which the transduction mechanism can be expressed as follows,

$$\vert \frac{d C}{d x} \vert = \frac{ɛ \cdot y}{z} -> Δ {C}_{x} = \frac{ɛ \cdot h}{z} \cdot Δ x , \qquad ( 6 )$$

in which “∈” represents the permittivity of the dielectric material (e.g., the air) disposed in the gap space between the finger 308 and the electrode 310, “z” represents the gap distance between the finger 308 and the electrode 310, “Δx” represents a change in the width, x, of the overlapping area, A₁, of the finger 308 and the electrode 310, and “ΔCₓ” represents a change in capacitance due to the relative movement of the finger 308 and the electrode 310. It is noted that changes in the overlapping areas of the finger/electrode pairs 208a/210b, 208b/210c, 208b/210d, and the corresponding transduction mechanisms, can be determined in a similar fashion. It is further noted that the relationship between the change in the capacitance, ΔCₓ, and the displacement of the proof mass is generally linear, as demonstrated by the constant multiplier,

$$`` \frac{ɛ \cdot h}{z} ″ ,$$

in equation (6) above. The capacitive sensing range of the exemplary MEMS capacitive sensor 200 employing variable-area sensing is therefore generally linear. It is noted that such linearity of the capacitive sensing range generally holds in the linear range of the plurality of spring beams 206 tethering the proof mass 204 to the substrate 202 (see FIG. 2).

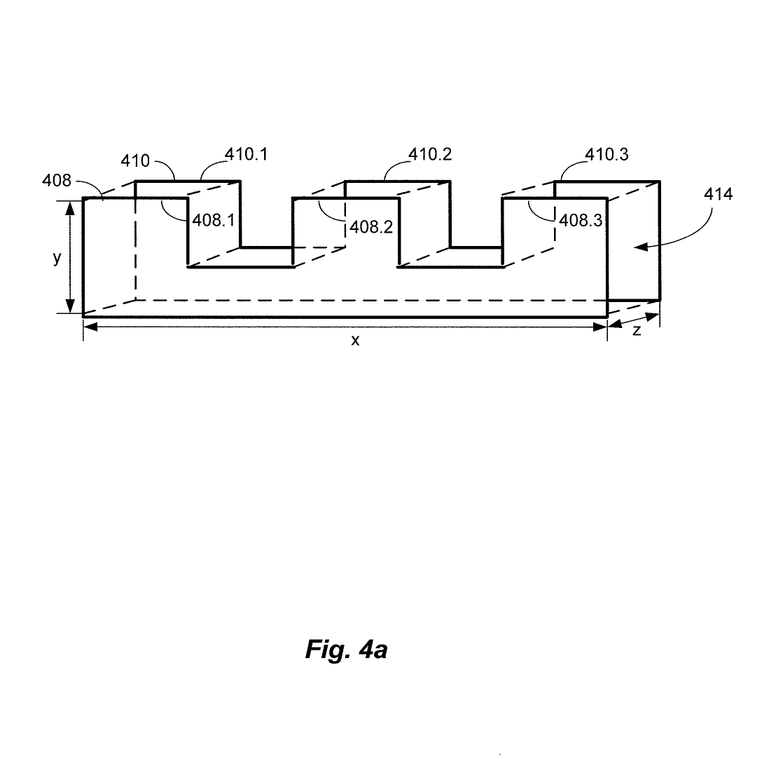

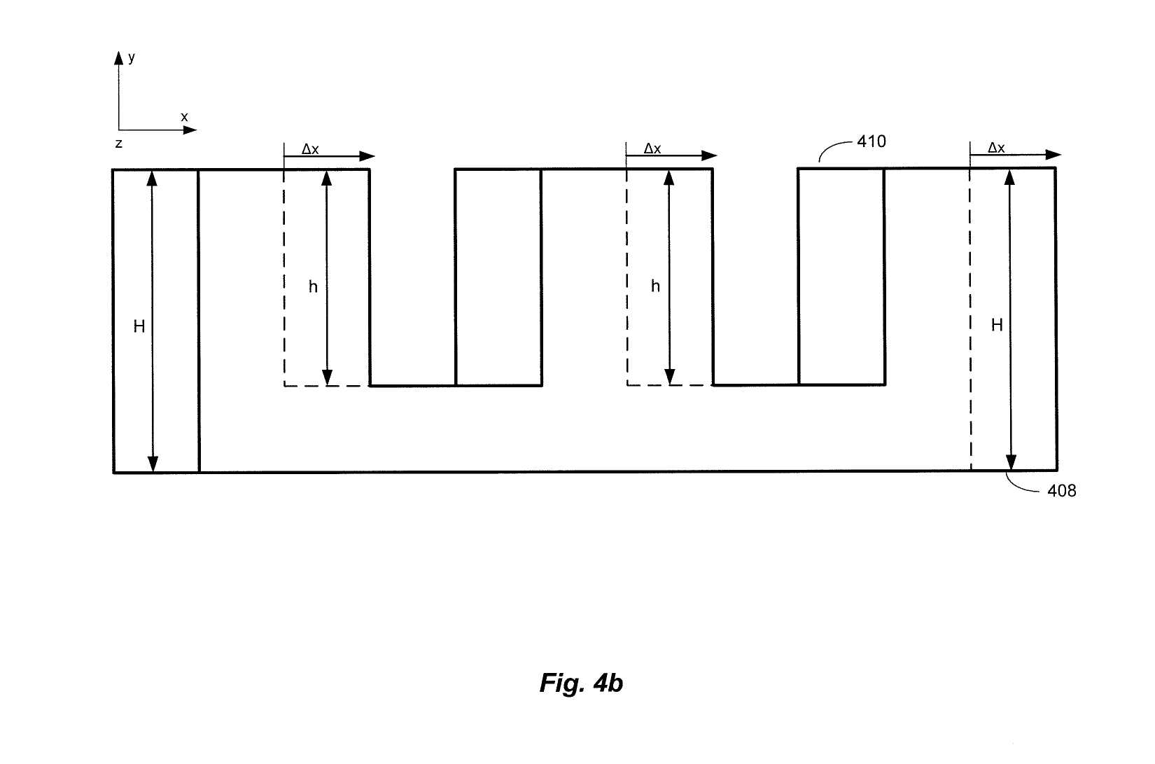

FIG. 4a depicts an alternative embodiment 408 (also referred to herein as the “finger 408”) of the finger 308 of FIGS. 3a and 3b, and an alternative embodiment 410 (also referred to herein as the “electrode 410”) of the electrode 310 of FIGS. 3a and 3b, in accordance with the present application. It is noted that the fingers 208a, 208b of FIG. 2 can be configured like the finger 408, and that each of the electrodes 210a, 210b, 210c, 210d of FIG. 2 can be configured like the electrode 410. Like the finger 308, the finger 408 is configured to extend from the proof mass 204, and, like the electrode 310, the electrode 410 is configured to be attached to the substrate 202. The finger 408 extending from the proof mass 204 is disposed adjacent to the electrode 410 attached to the substrate 202, thereby forming a substantially invariable gap 414 between the finger 408 and the electrode 410. The gap space formed by the invariable gap 414 is filled with a dielectric material, such as the air or any other suitable dielectric material. The finger 408 has a rectangular tooth profile that may include two, three, four, or any other suitable number of substantially rectangular teeth, such as the rectangular teeth 408.1, 408.2, 408.3. Similarly, the finger 410 has a rectangular tooth profile that may include two, three, four, or any other suitable number of substantially rectangular teeth, such as the rectangular teeth 410.1, 410.2, 410.3. It should be noted, however, that each of the finger 408 and the electrode 410 can have a tooth profile that includes multiple teeth having square shapes, rounded shapes, or any other suitable geometric shapes. As shown in FIG. 4a, “x” and “y” represent the width and the height, respectively, of an overlapping area, “A₂”, of the finger 408 and the electrode 410.

FIG. 4b depicts a plan view of the finger 408 and the electrode 410 having respective rectangular tooth profiles. The finger 408 and the electrode 410 with the dielectric material disposed in the gap space therebetween forms a variable, parallel-plate capacitor. With reference to FIG. 4b, the height, y, is set to the constant value H. With further reference to FIG. 4b, a change, “ΔA₂”, in the overlapping area, A₂, caused by relative movement of the finger/electrode pair 408/410, in response to a displacement of the proof mass 204 (as indicated by the arrow 216; see FIG. 2), can be expressed as follows,

ΔA₂=(n−1)·h·Δx+H·Δx (7)

in which “h” and “Δx” represent the constant height and the variable width, respectively, of that portion of the change, ΔA₂ in the overlapping area, A₂, corresponding to each respective rectangular tooth pair 408.1/410.1, 408.2/410.2, 408.3/410.3, and “n” is equal to the number of teeth in the rectangular tooth profiles of each of the finger 408 and the electrode 410, namely, three. Moreover, for the finger/electrode pair 408/410, capacitive sensing is achieved via variable-area sensing, for which the transduction mechanism can be expressed as in equation (6), which is reproduced for convenience below.

$$\vert \frac{d C}{d x} \vert = \frac{ɛ \cdot y}{z} -> Δ {C}_{x} = \frac{ɛ \cdot h}{z} \cdot Δ x \qquad ( 6 )$$

With reference to FIG. 4b and equation (6) above, “∈” represents the permittivity of the dielectric material (e.g., the air) disposed in the gap space between the finger 408 and the electrode 410, “z” represents the invariable gap distance between the finger 408 and the electrode 410, “Δx” represents a change in the width, x, of the overlapping area, A₂, of the finger 408 and the electrode 410, and “ΔCₓ” represents a change in capacitance due to the relative movement of the finger 408 and the electrode 410.

As discussed above with reference to the finger 308 and the electrode 310, the relationship between the change in the capacitance, ΔCₓ, and the displacement of the proof mass is generally linear for finger/electrode pairs configured like the finger 408 and the electrode 410. The capacitive sensing range of the exemplary MEMS capacitive sensor 200 including such finger/electrode pairs is therefore generally linear. Because the portion, h·Δx, of the change, ΔA₂, in the overlapping area, A₂, corresponding to each rectangular tooth pair 408.1/410.1, 408.2/410.2, 408.3/410.3 is multiplied by the number, n, of rectangular teeth (e.g., n·h·Δx; see equation (7) above), while the standing capacity of the MEMS capacitive sensor 200 remains relatively high, the sensitivity of the MEMS capacitive sensor 200 employing variable-area sensing is significantly increased per unit area of the fingers 408.1-408.3 and the electrodes 410.1-410.3.

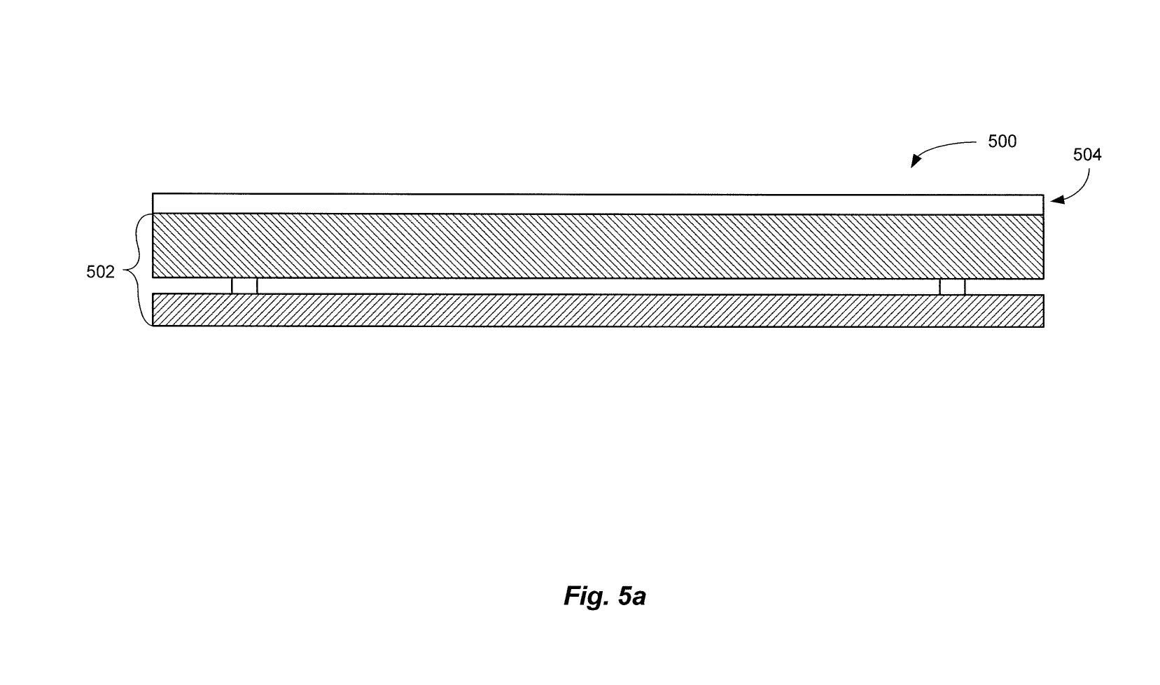

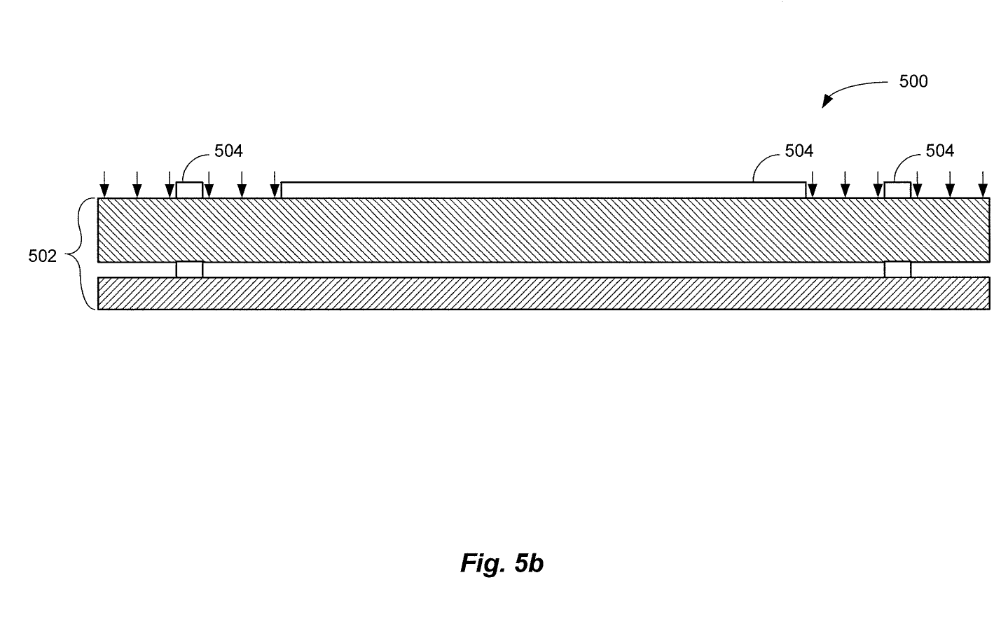

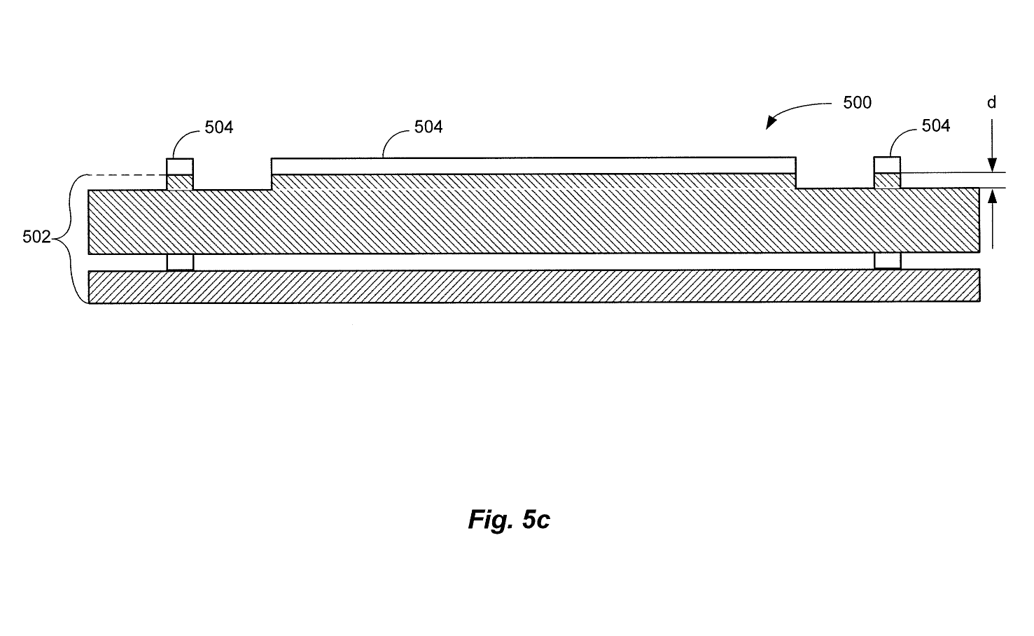

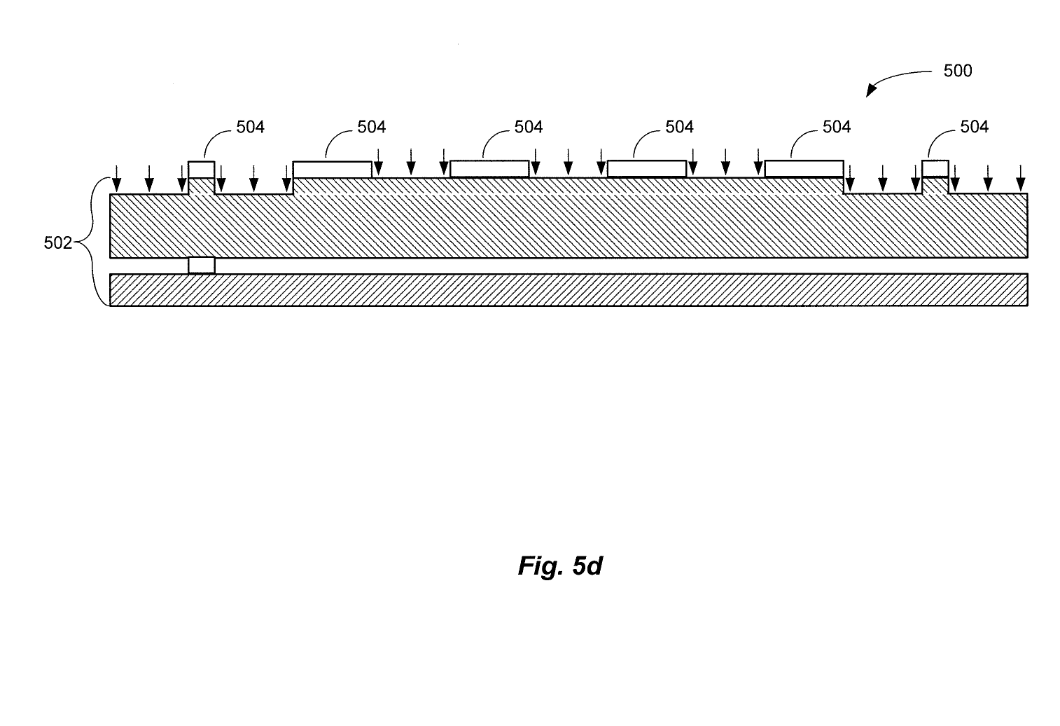

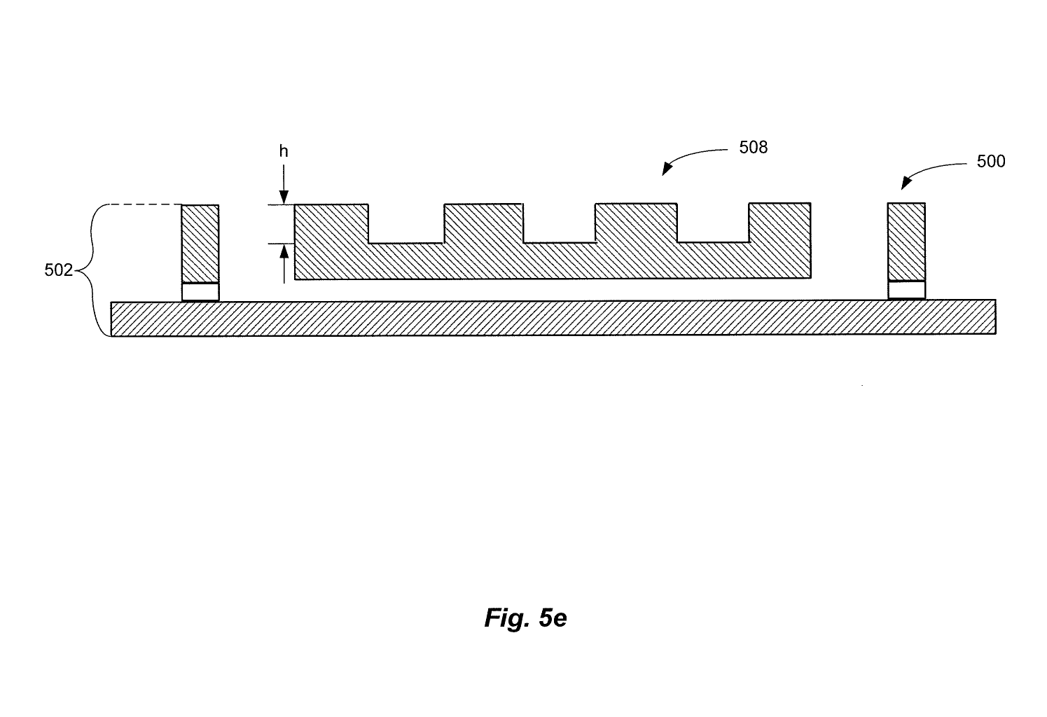

FIGS. 5a-5e illustrate an exemplary fabrication process flow for producing the disclosed micro-machined capacitive sensor implemented in a MEMS process, in accordance with the present application. As shown in FIG. 5a, the surface of a substrate 502 is covered with a protection film 504 such as photoresist, polyimide, metal, oxide, or any other suitable type of protection film. A predetermined pattern is imaged in or otherwise transferred to the protection film 504, thereby obtaining a deep reactive ion etching (DRIE) mask for use in forming a MEMS structure in the substrate 502 including at least one finger or electrode having a rectangular tooth profile 508 (see FIG. 5e), a proof mass, spring beams, etc. As shown in FIG. 5b, the finger or electrode is etched in the substrate 502 using the DRIE mask. As shown in FIG. 5c, DRIE etching of the substrate 502 is continued until a specified depth, d, in the substrate 502 is reached. As shown in FIG. 5d, portions of the protection film 504 are removed, and the resulting exposed regions of the substrate 502 are partly etched to obtain the substantially rectangular shape of the rectangular tooth profile 508. As shown in FIG. 5e, the DRIE etching of the substrate 502 is continued to release the MEMS structure, while ensuring that the base of the rectangular tooth profile 508 has a specified height, h, sufficient to provide good mechanical stability and good electrical connections.

It will be appreciated that the above-described exemplary MEMS capacitive sensor 200 (see FIG. 2), including the finger 408 (see FIGS. 4a and 4b) and the electrode 410 (see FIGS. 4a and 4b) having respective rectangular tooth profiles, may be incorporated into a capacitive accelerometer implemented in a MEMS process (referred to herein as the “MEMS capacitive accelerometer”). In the MEMS capacitive accelerometer, the change, Δx, in the width, x, of the overlapping area, A₂, of the finger/electrode pair 408/410 is in response to an applied acceleration causing a displacement of the proof mass 204. Further, in the MEMS capacitive accelerometer, it is expected that the capacity change of the device would be linear with the applied acceleration in the linear range of the spring beams 206 tethering the proof mass 204 to the substrate 202 (see FIG. 2).

It will be further appreciated by those skilled in the art that modifications to and variations of the above-described micro-machined capacitive sensors implemented in micro-electro-mechanical system (MEMS) processes may be made without departing from the inventive concepts disclosed herein. Accordingly, the disclosure should not be viewed as limited except as by the scope and spirit of the appended claims.

What is claimed is:

1. A capacitive sensor, comprising:
a substrate;
a mass;
a plurality of spring beams coupling the mass to the substrate;
at least one first electrode extending from the mass; and
at least one second electrode attached to the substrate,
wherein the first electrode is disposed adjacent to the second electrode to form a substantially invariable gap between the first and second electrodes, and
wherein each of the first and second electrodes has a tooth profile including a plurality of teeth, each of the plurality of teeth having a predetermined geometric shape.

2. The capacitive sensor of claim 1 wherein the predetermined geometric shape of the respective teeth includes a substantially rectangular shape.

3. The capacitive sensor of claim 1 wherein the predetermined geometric shape of the respective teeth includes a substantially square shape.

4. The capacitive sensor of claim 1 wherein the predetermined geometric shape of the respective teeth includes a substantially rounded shape.

5. The capacitive sensor of claim 1 further including a dielectric material disposed in the substantially invariable gap between the first and second electrodes, and wherein the first electrode, the second electrode, and the dielectric material disposed in the substantially invariable gap between the first and second electrodes form a parallel-plate capacitor.

6. The capacitive sensor of claim 5 wherein the parallel-plate capacitor has an associated capacitance, wherein the first electrode disposed adjacent to the second electrode defines an overlapping area of the first and second electrodes, and wherein the capacitance of the parallel-plate capacitor changes in response to a displacement of the mass, thereby causing a corresponding change in the overlapping area of the first and second electrodes.

7. The capacitive sensor of claim 1 wherein the plurality of teeth of the tooth profile includes at least two teeth.

8. The capacitive sensor of claim 1 wherein the at least one first electrode extending from the mass includes a plurality of first electrodes extending from the mass.

9. The capacitive sensor of claim 8 wherein the at least one second electrode attached to the substrate includes a plurality of second electrodes attached to the substrate.

10. The capacitive sensor of claim 9 wherein the plurality of first electrodes are disposed adjacent to the plurality of second electrodes to form a plurality of substantially invariable gaps between specified pairs of the first and second electrodes.

11. A method of fabricating a capacitive sensor, comprising the steps of:
covering a surface of a substrate with a protection film;
transferring a predetermined pattern to the protection film to obtain a mask for forming at least one electrode in the substrate, the electrode having a tooth profile including a plurality of teeth, each of the plurality of teeth having a predetermined geometric shape;
in a first etching step, etching, using the mask, the electrode having the tooth profile to a specified depth in the substrate;
removing portions of the protection film to expose a plurality of regions on the surface of the substrate, the plurality of regions corresponding to locations between the plurality of teeth of the tooth profile;
in a second etching step, at least partly etching the exposed regions of the substrate to obtain the predetermined geometric shape of the plurality of teeth of the tooth profile; and
in a third etching step, etching the substrate to release the at least one electrode having the tooth profile from the substrate.

12. The method of claim 11 wherein the predetermined geometric shape of the respective teeth includes a substantially rectangular shape.

13. The method of claim 11 wherein the predetermined geometric shape of the respective teeth includes a substantially square shape.

14. The method of claim 11 wherein the predetermined geometric shape of the respective teeth includes a substantially rounded shape.

15. The method of claim 11 wherein each of the first, second, and third etching steps includes deep reactive ion etching (DRIE) of the substrate.
